(19) United States
(12) Patent Application Publication
(10) Pub. No.: US 2022/0026594 A1
(43) Pub. Date: Jan. 27, 2022

(54) CUSTOMIZED CANONICAL DATA STANDARDIZATION, INGESTION, AND STORAGE

(71) Applicant: Schlumberger Technology Corporation, Sugar Land, TX (US)

(72) Inventors: Chinmoy Mohanty, Houston, TX (US); Abhay Dutt Paroha, Houston, TX (US); Sonal Savartkar, Pune (IN); Naman Bairagi, Houston, TX (US); Garima Hooda, Pune (IN)

(21) Appl. No.: 17/309,101

(22) PCT Filed: Oct. 29, 2019
(86) PCT No.: PCT/US2019/058437

§ 371 Date: Apr. 23, 2021

Related U.S. Application Data
(60) Provisional application No. 62/752,039, filed on Oct. 29, 2018.

(51) Int. Cl. G01V 1/32; G01V 1/30; G01V 1/24; G06F 16/25; G06F 16/23

(52) U.S. Cl. CPC G01V 1/32; G01V 1/30; G06F 16/2386; G06F 16/258; G01V 1/247

(57) ABSTRACT

A method for customized canonical data standardization, ingestion, and storage includes: receiving a configuration set defining a formatting parameter, a unit conversion parameter, and a transmission parameter, receiving a data record from a data source, wherein the data record includes oilfield-related data, converting units within the data record to a standardized unit defined based at least partially on the unit conversion parameter, formatting the data record based at least partially on the formatting parameter, wherein the formatting parameter defines one or more modifications to make to the data record, and providing the data record to a cloud hosting system for storage after converting the units and the formatting the data record, wherein the providing the data record comprises transmitting the data record in a manner defined by the configuration set.

### CROSS-REFERENCE TO RELATED APPLICATIONS

This application claims priority to U.S. Provisional Patent Application having Ser. No. 62/752,039, which was filed on Oct. 29, 2018, and is incorporated herein by reference in its entirety.

### BACKGROUND

In the oil and gas production industry, operational decisions may be made based on inputs from various field devices, operator inputs, and application of analytical methods on existing data. A number of tools are available to facilitate such decision-making, including Production Data Management Systems (PDMS), real-time surveillance systems, customized historian/buffers, sensor data sources, etc. These tools have varying capabilities and scale, and may provide independent and isolated storage of raw or calculated production data, model and derived artefacts.

### SUMMARY

Embodiments of the disclosure may include a method for customized canonical data standardization, ingestion, and storage. The method may include receiving a configuration set defining a formatting parameter, a unit conversion parameter, and a transmission parameter, receiving a data record from a data source, wherein the data record includes oilfield-related data, converting units within the data record to a standardized unit defined based at least partially on the unit conversion parameter, formatting the data record based at least partially on the formatting parameter, wherein the formatting parameter defines one or more modifications to make to the data record, and providing the data record to a cloud hosting system for storage after converting the units and the formatting the data record, wherein the providing the data record comprises transmitting the data record in a manner defined by the configuration set.

In another embodiment, a computing system includes one or more processors and a memory system including one or more non-transitory computer-readable media storing instructions that, when executed by at least one of the one or more processors, cause the computing system to perform operations. The operations may include receiving a configuration set defining a formatting parameter, a unit conversion parameter, and a transmission parameter; receiving a data record from a data source, wherein the data record includes oilfield-related data; converting units within the data record to a standardized unit defined based at least partially on the unit conversion parameter; formatting the data record based at least partially on the formatting parameter, wherein the formatting parameter defines one or more modifications to make to the data record; and providing the data record to a cloud hosting system for storage after converting the units and the formatting the data record, wherein the providing the data record comprises transmitting the data record in a manner defined by the configuration set.

In another embodiment, there is a non-transitory computer-readable medium storing instructions that, when executed by one or more processors of a computing system, cause the computing system to perform operations. The operations may include receiving a configuration set defining a formatting parameter, a unit conversion parameter, and a transmission parameter; receiving a data record from a data source, wherein the data record includes oilfield-related data; converting units within the data record to a standardized unit defined based at least partially on the unit conversion parameter; formatting the data record based at least partially on the formatting parameter, wherein the formatting parameter defines one or more modifications to make to the data record; and providing the data record to a cloud hosting system for storage after converting the units and the formatting the data record, wherein the providing the data record comprises transmitting the data record in a manner defined by the configuration set.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 shows an example of a system that includes various management components to manage various aspects of a geologic environment, according to an embodiment.

FIG. 2 shows an example environment, according to an embodiment.

FIG. 3 shows an example implementation for receiving, converting, formatting, batching, transmitting, and storing data records to a cloud hosting system, according to an embodiment.

FIG. 4 shows an example diagram illustrating the transmitting and storing different types of data in a cloud hosting system, according to an embodiment.

FIG. 5 shows an example flowchart of a process for standardizing data records for efficient transmission and storage on a cloud hosting system, according to an embodiment

FIG. 6 shows a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Data analysis often involves the collection and interpretation of data across disparate sources with disparate formats and structures. Cloud data storage may be implemented to conveniently consolidate data into a central location. While cloud data storage may be helpful in consolidating data, existing solutions are deficient in providing a canonical data model to standardize data from multiple disparate sources and formats, and streaming data to the cloud in a resource-efficient manner. As such, data interpretation and analysis of different types of data in different formats may be difficult and time consuming, and the consumption of computing and network resources are often wasted through inefficient cloud streaming and cloud data storage protocols. Accordingly, aspects of the present disclosure provide data collection, cloud streaming, and cloud data consolidation using canonical data standardization techniques while providing customization for balancing the efficiency of consumption of network resources, computer resources, and computer processing cycles with the richness of data that is collected streamed, and stored to a cloud data hosting system. As used herein, the “richness” of data generally refers to a level of information and/or a payload size of the data.

As further described herein, aspects of the present disclosure may incorporate contracts that define a customizable configuration and manner in which data is to be standardized and streamed to a cloud data hosting system such that all data is stored in a consistent manner that does not deviate from the configuration. In some embodiments, an onsite agent computing system may be implemented to receive data from one or more data sources, receive configuration information and/or contract information, convert and translate the data into standardized units and formats in accordance with the configuration information, and stream formatted data records to a cloud hosting system for centralized storage.

As described herein, the configuration information may be customized to further define protocols that the onsite agent system may use to stream or provide formatted data records to the cloud hosting system. As illustrative examples, the configuration information may define time periods, time intervals, network protocols, network quality of service (QoS) parameters, network paths, bandwidth limits, file size limits and/or other constraints/parameters defining the procedures for providing data to the cloud hosting system. In some embodiments, the configuration information may be based on constraints imposed by the cloud hosting system, and/or a service level agreement (SLA) between the onsite agent system and the cloud hosting system. In this way, the onsite agent system and the cloud hosting system may work in conjunction for providing a cloud data storage solution that standardizes data across disparate sources and formats, and further balances data richness with data transmission resource and storage consumption efficiency. As an example, a configuration set may be customized to define parameters that balance the data richness needs with data transmission resource and storage consumption efficiency needs. A configuration set may be generated to balance these factors, or the configuration set may be derived from an SLA that defines such parameters. For example, one configuration set may allow for higher data richness if the resource consumption tolerance for transmission and storage is high and if higher data richness is desired for a particular application, data analysis workflow, or group. Conversely, a different configuration set may permit a lower level of data richness if that lower level of data richness is sufficient for a particular application, workflow, or group, thereby reducing transmission and storage resource costs.

In some embodiments, the onsite agent system may incorporate internal file-based storage techniques to maintain markers of time to identify the time range of when data was delivered or streamed to the cloud hosting system. These markers may be used to determine a subsequent time in which to stream or provide data to the cloud hosting system based on when data was previously provided to the cloud hosting system. As described herein, the onsite agent system may maintain a connection with the cloud hosting system to receive command messages (e.g., configuration information, configuration changes, data uploading triggers etc.). Further, the onsite agent system may micro-batch data when providing to the cloud hosting system to improve cost effectiveness of data transmission and storage. In some embodiments, the onsite agent system may operate based on the latest configuration pushed from the cloud hosting system. The onsite agent system may request configuration upon startup, periodically, or on-demand.

In some embodiments, the onsite agent system may incorporate internal fault tolerances to ignore and/or log configurations and commands that are outside of tolerance thresholds or that do not satisfy a set of criteria. As one illustrative example, the onsite agent system may ignore configuration files that instruct the onsite agent system to send data to the cloud hosting system at excessively short time periods, or commands that are inconsistent with parameters from an SLA, or other set of guidelines.

In some embodiments, the onsite agent system may append timestamps to data records in a standardize time zone (e.g., the coordinated universal time zone or UTC time), and may convert to the UTC time zone appropriately. Further, the onsite agent system may standardize units of data (e.g., to an international system of units (SI units)) such that all data records have a consistent format with standardized units and standardized timestamps. Further, the onsite system agent may incorporate health monitoring techniques and/or report health statistics to the cloud hosting system to identify malfunctioning onsite agent systems.

Embodiments of the present disclosure may provide a system and/or method that enables the secure data ingestion from different data sources through on-premise adaptors and storage of the ingested data on the cloud (e.g., storage accessible through remote servers) using bi-temporal canonical data schema, which preserve the history of data. Further, aspects of the present disclosure allow the ingestion of different types of data. For example, aspects of the present disclosure may ingest low frequency asset hierarchy data, such as data that may exist on a corporate database or Production Data Management system. Additionally, or alternatively, aspects of the present disclosure may ingest high frequency tag-based measurements from a set of sensors, historian system, or the like. Additionally, or alternatively, aspects of the present disclosure may ingest any other types of data, such as data from structure query language (SQL) databases, open database connectivity (ODBC) databases, structure data, non-structure data, incremental data, timeseries data, or the like. As described herein, onsite agent systems may fetch or obtain data from respective data sources, ingest the data, standardize the data, and disseminate the data to a cloud hosting system to make the data easily accessible to end-users. Further, aspects of the present disclosure provide secure data ingestion, the ability to support millions of data points per second, and reduce data delivery and storage costs.

As one illustrative example, aspects of the present disclosure may assist production engineers to obtain and analyze data relating to high priority wells for improving performance (e.g., identify oil production relative to production estimates, and potentially improve production). Additionally, or alternatively, aspects of the present disclosure may be implemented to provide diagnosis of a condition accompanied by a recommendation of an action to resolve the condition via workflows on top of data storage. As another illustrative example, a product may incorporate one more aspects of the present disclosure in the production domain to provide progress in terms of exploiting opportunities to ingest high and low frequency of production data originating from different data sources with assured scalability and future readiness to handle big data and/or cloud-level data volume demands.

Further, aspects of the present disclosure may be employed to check the quality of data prior to running actual workflows. While some example use cases have been described, it is emphasized that the systems and/or methods, described herein, are not so limited to these examples. In practice, the techniques described herein may be applied to any types of data for improving data transmission and storage efficiency, and data record standardization.

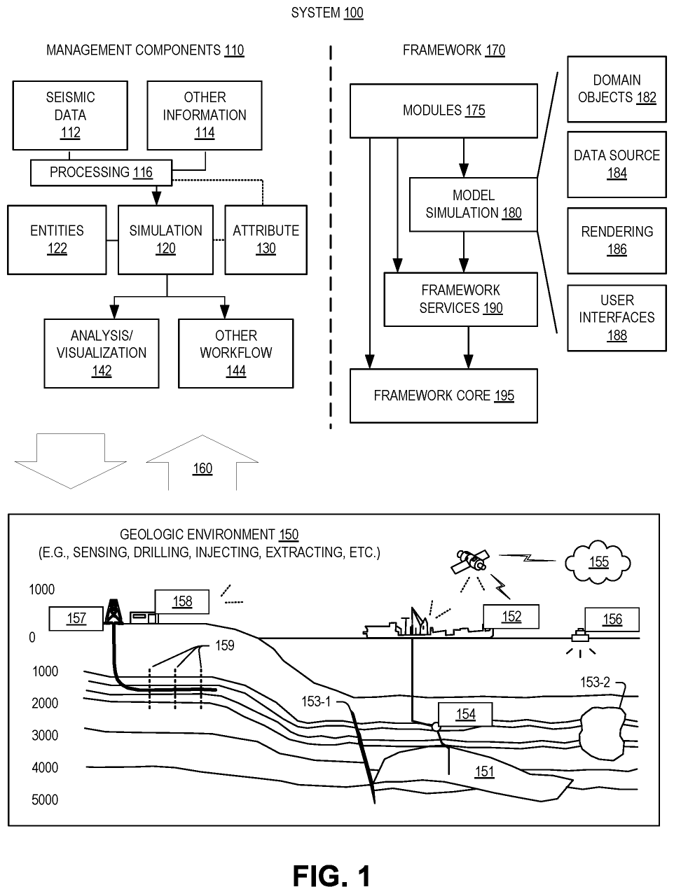

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

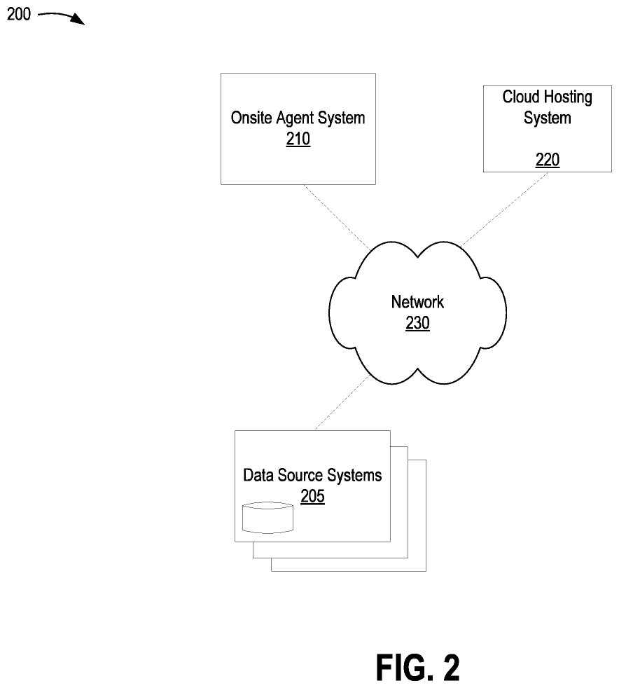

FIG. 2 shows an example environment 200 in accordance with aspects of the present disclosure. As shown in FIG. 2, the environment 200 includes data source systems 205, an onsite agent system 210, a cloud hosting system 220, and a network 230. In some embodiments, one or more components in environment 200 may correspond to one or more components in the cloud computing environment of FIG. 2. In some embodiments, one or more components in environment 200 may include the components of the system 100 of FIG. 1.

The data source systems 205 may include one or more computing systems, databases, sensor systems, data acquisition systems, and/or other types of systems that obtain any type of data from one or more systems. As one illustrative example, the data source systems 205 may obtain sensor data from the system 100 of FIG. 1. Additionally, or alternatively, the data source systems 205 may include various types of data from various sources, such as from Production Data Management Systems (PDMS), real-time surveillance systems, customized historian/buffers, incremental data sources, structure or non-structure data, sensor data (e.g., from the geological environment 150), SQL databases, OBDC databases, data related to oilfield systems/equipment or the like. In some embodiments, the data source systems 205 may generate data records having raw data (e.g., raw sensor readings/measurements, etc.). In some embodiments, the data records may include a timestamp identifying the time in which the raw data was collected.

The onsite agent system 210 may include one or more computing devices that obtain data records from the data source systems 205, receive configuration information from the cloud hosting system 220, convert/standardize the data in accordance with the configuration information, and provide the converted and standardized data records to the cloud hosting system 220 in accordance with transmission procedures defined in the configuration information. In some embodiments, the onsite agent system 210 may provide additional features, such as offline storage, data buffering, customized unit conversion and/or the ability to detect missing data or incorrect values. In some embodiments, the onsite agent system 210 may operate in isolation (e.g., with no connections to external endpoints). In some other embodiments, the onsite agent system 210 may operate in conjunction with any number of other devices, systems, and endpoints. In some embodiments, the onsite agent system 210 may pull or refresh configuration data from the cloud hosting system 220 periodically, upon startup, and/or on-demand on an on-need basis. Configuration changes, such as data mapping and connection settings, may also be pushed from the cloud hosting system 220 to the onsite agent system 210. In some embodiments, environment 200 may include an onsite agent system 210 that resides onsite, but may also include, in-cloud agents residing within the cloud hosting system 220, which may not be treated differently architecturally than onsite agent systems 210.

The cloud hosting system 220 may include one or more computing devices that store data records provided by the onsite agent system 210. For example, the cloud hosting system 220 may store the data records after conversion and standardization by the onsite agent system 210. In some embodiments, the cloud hosting system 220 may include a cloud messaging component to communicate with the onsite agent system 210 (e.g., to communicate commands, configuration information, etc.). Additionally, or alternatively, the cloud hosting system 220 may include a cloud authorization framework to securely ingest data records and verify that data records are received from a trusted onsite agent system 210. In some embodiments, the cloud hosting system 220 may include ingestion pipelines that verify that the data records are formatted correctly with respect to a configuration defining the format prior to storage. As described herein, the cloud hosting system 220 may provide configuration information to the onsite agent system 210 in which the configuration information defines the format and standardization of data records, as well as data transmission procedures and protocols that balance the richness of the data with the resource consumption efficiency tolerances of data transmission and storage. In some embodiments, these configuration definitions may be customizable and provided by one or more data/production engineers or groups based on their customized needs and applications. For example, one configuration set may allow for higher data richness if the resource consumption tolerance for transmission and storage is high and if higher data richness is desired for a particular application, data analysis workflow, or group. Conversely, a different configuration set may permit a lower level of data richness if that lower level of data richness is sufficient for a particular application, workflow, or group, thereby reducing transmission and storage resource costs.

The network 230 include network nodes, one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In some embodiments, the network 230 may include copper transmission cables, optical transmission fibers, wireless transmission, routers, firewalls, switches, gateway computers and/or edge servers.

Any number of devices and/or networks may form part of the environment 200. In various embodiments, the environment 200 may include additional devices and/or networks; fewer devices and/or networks; different devices and/or networks; or differently arranged devices and/or networks than illustrated in FIG. 2. Also, in some embodiments, one or more of the devices of the environment 200 may perform one or more functions described as being performed by another one or more of the devices of the environment 200. Devices of the environment 200 may interconnect via wired connections, wireless connections, or a combination of wired and wireless connections.

In some embodiments, any number of components, devices, and/or networks may be implemented within the environment 200. As an illustrative example, two types of components may be provided (e.g., onsite agent systems 210210, and a set of microservices deployed on or within the cloud hosting system 220 in Kubernetes cluster). The cloud hosting system 220 may host a container platform, which in turn hosts containers, which hosts individual services which communicate with a cloud-based storage system. The container platform may the provide portability across multiple onsite agent systems 210220. The containers may include or provide similar functionality as virtual machines, but consume significantly fewer resources, making it possible to start a new container in seconds rather than minutes. This startup efficiency may improve elastic scalability on the cloud hosting system 220, which forms the basis of the capital expenses vs operational expenses tradeoff. Each container may provide the features and/or functionalities of a virtual machine in terms of machine addressability, runtime environment isolation and resilience in deployment through fine grained control over the installed image. The container platform may include a network of containers located transparently across one or many machines.

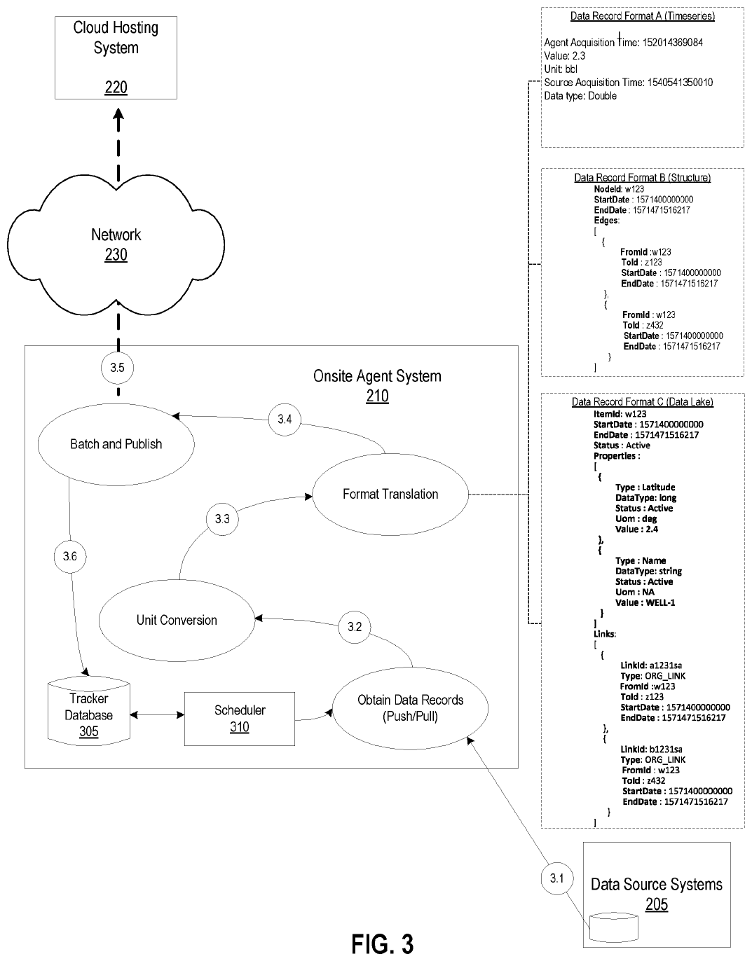

FIG. 3 shows an example of receiving, converting, formatting, batching, transmitting, and storing data records to a cloud hosting system, according to an embodiment. As shown in FIG. 3, the onsite agent system 210 may obtain data records from one or more data source systems 205 on a push/pull basis (e.g., at 3.1). In some embodiments, the onsite agent system 210 may implement a schedule 310 to schedule when data records will be pulled. At 3.2, the onsite agent system 210 may perform unit conversion on the units within the data records (e.g., to standardize the data units to facilitate efficient workflow execution and/or data analysis). At 3.3, the onsite agent system 210 may perform format translation to format the data records in accordance with a customizable configuration set. In some embodiments, the formatting may involve pruning, discarding, compressing, expanding, and/or rearranging of the data. As described herein, the formatting may define the richness level of the data to balance data richness with transmission and storage efficiency. The formatting may be based on a configuration set that balances data richness with transmission and storage resource consumption efficiency. For example, one formatting configuration may define relatively richer data than a different formatting configuration.

In one example shown in FIG. 3 (e.g., data record format A, or timeseries data), the data record may include time series data from an historian data source, such as sensor measurement data. As an example, the data record may include a value identifying a time in which the data was obtained by the onsite agent system 210 (e.g., the “agent acquisition time”), a value of the data (e.g., a value of the sensor measurement), a unit corresponding to the data value, a time in which the data was acquired by the source data system 205 (e.g., the “source acquisition time”), and a type of the data.

As another example shown in FIG. 3 (e.g., data format B or structure data), the data record may be formatted differently than that of data format A, as shown. As another example shown in FIG. 3 (e.g., data format C or “Data Lake” type data), the data record may be formatted differently than that of data format A and B, as shown. Further, data formats of different types may have different levels of richness, formatting, units, etc. It is noted that in practice, the data record may include additional or less information and formatted differently than shown in which the data record and its format may have any level of richness as defined by a configuration set.

At 3.4, the onsite agent system 210 may batch the data records (e.g., after unit conversion and format translation). At 3.5, the onsite agent system 210 may publish or transmit the batched data records to the cloud hosting system 220 via the network 230. At 3.6 may communicate with a tracker database 305 to store a marker identifying a time as to when the data records were transmitted to the cloud hosting system 220. The scheduler 310 may use these markers to schedule the subsequent transmission of additional data records based on a prior time in which the data records were transmitted. For example, the schedule 310 may schedule a subsequent transmission of additional data records after a particular amount of time has elapsed since a prior transmission.

In the example shown in FIG. 3, the onsite agent system 210 and the cloud hosting system 220 may work in conjunction to provide a complete solution for cloud data consolidation using canonical data application techniques. Further, the onsite agent system 210 and cloud hosting system 220 work in conjunction for balancing the efficiency of consumption of network resources, computer resources, and computer processing cycles with the richness of data that is collected streamed, and stored to a cloud data hosting system.

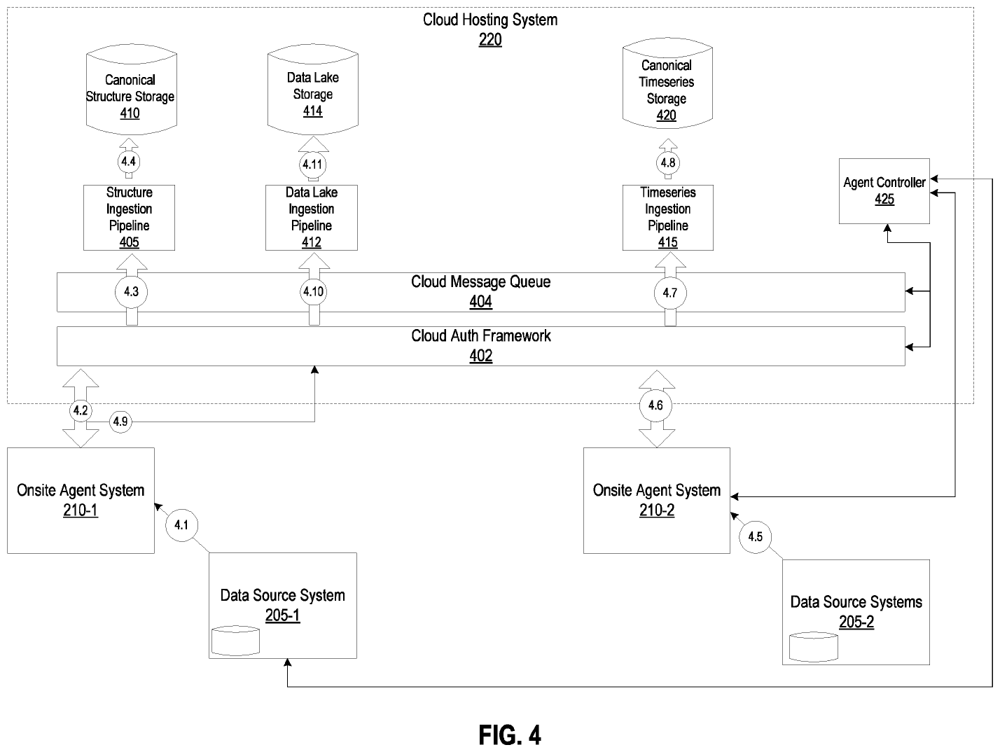

FIG. 4 shows an example diagram illustrating the transmitting and storing different types of data in a cloud hosting system according to an embodiment. More specifically, FIG. 4 illustrates operations performed by the cloud hosting system 220 for securely communicating with and ingesting different types of data records from a first onsite agent system 210 (e.g., onsite agent system 210-1) and a second onsite agent system 210 (e.g., onsite agent system 210-2). Further, the cloud hosting system 220 implements ingestion pipelines to verify the formatting of the data records received by the onsite agent system 210-1 and the onsite agent system 210-2 prior to storage.

As shown in the example of FIG. 4, at 4.1, the onsite agent system 210-1 may receive data records of a first type (e.g., structure data) from a first data source system 205 (e.g., data source system 205-1). At 4.2, the onsite agent system 210-1 may transmit the data records to the cloud hosting system 220 (e.g., after unit conversion, formatting, and batching, similar to the process described in FIG. 3). That is, the onsite agent system 210-1 may produce canonical data records having standardized units and formatting, and provide the canonical data records to the cloud hosting system 220. As part of the data records transmission, a cloud auth framework 402 may authenticate the onsite agent system 210-1 using registration information and/or any suitable authentication technique. At step 4.3, the data records may be provided (e.g., via a cloud message queue 404) to a first type of ingestion pipeline (e.g., a structure ingestion pipeline 405). In some embodiments, the structure ingestion pipeline 405 may verify that the data records are formatted in accordance with a configuration set defining the formatting and units of the structure type data records. Based on this verification, at step 4.4, the structure ingestion pipeline 405 may provide data records for storage in a canonical structure storage 410.

In a similar manner, the cloud hosting system 220 may receive, process, and store data records of a different type (e.g., timeseries data records). For example, at 4.5, The onsite agent system 210-2 may receive timeseries data from a second data source system 205 (e.g., data source system 205-2). At 4.6, the onsite agent system 210-2 may produce canonical timeseries data records, and transmit the data records to the cloud hosting system 220 (e.g., after unit conversion, formatting, and batching, similar to the process described in FIG. 3). As part of the data records transmission, a cloud auth framework 402 may authenticate the onsite agent system 210-2 using registration information and/or any suitable authentication technique. At step 4.7, the data records may be provided (e.g., via a cloud message queue 404) to a second type of ingestion pipeline (e.g., a timeseries ingestion pipeline 415). In some embodiments, the timeseries ingestion pipeline 415 may verify that the data records are formatted in accordance with a configuration set defining the formatting and units of the timeseries type data records. Based on this verification, at step 4.8, the timeseries ingestion pipeline 415 may provide data records for storage in a canonical timeseries storage 420.

In some embodiments, the cloud hosting system 220 may receive, process, and provide long-term storage of raw structural data records (e.g., associated data and/or metadata). As an example, the cloud hosting system 220 may provide long-term storage of raw data relating to the PDMS structure data. In some embodiments, the onsite agent system 210-1 may ingest structural data along with its metadata, to be stored in long-term raw data storage (e.g., data lake storage 414). The data stored in the data lake storage 414 may differ from the structure data (e.g., stored in the canonical structure storage 410) in terms of the extra metadata and properties which are linked to the structural entity. The data lake storage 414 may include a replicated (or near replicated) representation of the raw structural data records provided by the data source system 205-1.

As shown in FIG. 4, at 4.9, the onsite agent system 210-1 may provide the raw structural data records to the cloud hosting system 220. At 4.10, the raw structural data records may bay received by a data lake ingestion pipeline 412 (e.g., via the cloud authorization framework 402 and the cloud message queue 404). The data lake ingestion pipeline 412 may verify that the data records are in a format consistent with a configuration set defining the formatting of data lake records (e.g., are in a format consistent with the raw data records acquired by the source data system 205-1). At 4.11, after the verification, the data lake ingestion pipeline 412 may provide the raw structural data records to the data lake storage 414 for storage. In this way, the cloud hosting system 220 may provide long-term storage of raw data records as they are acquired and provided by the data source system 205-1.

As further shown in FIG. 4, the cloud hosting system 220 may include an agent controller 425. In some embodiments, the agent controller 425 may communicate with each of onsite agent system 210-1 and onsite agent system 210-2 (e.g., either directly or via the cloud message queue 404). In some embodiments, the agent controller 425 may provide command messages, configuration updates, and/or other types of messages and instructions for the onsite agent system 210-1. Additionally, or alternatively, the agent controller 425 may receive health monitoring statistics from the onsite agent system 210-1 and the onsite agent system 210-2.

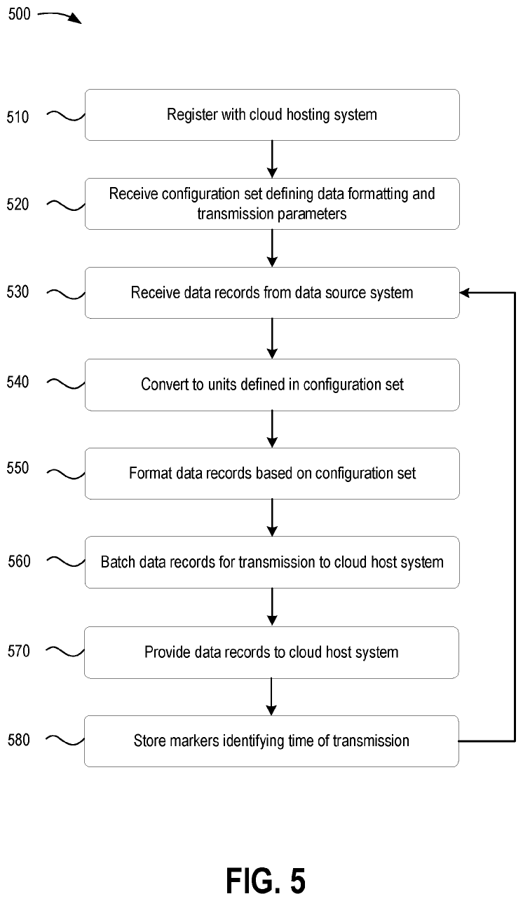

FIG. 5 shows an example flowchart of a process 500 for standardizing data records for efficient transmission and storage on a cloud hosting system, according to an embodiment. The process 500 may be implemented in the environment of FIG. 2, for example, and are described using reference numbers of elements depicted in FIG. 2. As noted herein, the flowchart illustrates the functionality and operation of possible implementations of systems, methods, and computer program products according to various embodiments of the present disclosure.

As shown in FIG. 5, the process 500 may include registering with a cloud hosting system (block 510). For example, the onsite agent system 210 may register with the cloud hosting system 220 as part of an initial setup and provisioning process. In some embodiments, the onsite agent system 210 may provide the cloud hosting system 220 with registration information, such as information identifying the onsite agent system 210, the location, site, or premises served by the onsite agent system 210, an organization or group associated with the onsite agent system 210, an SLA associated with the onsite agent system 210 (or an SLA associated with the associated group or organization) the type of data to be collected and transmitted by the onsite agent system 210, hardware and software configuration information, network configuration information, applications, virtual machines, and environments hosted by the onsite agent system 210, or the like. Additionally, or alternatively, the onsite agent system 210 may provide any other type of information to the cloud hosting system 220 that the cloud hosting system 220 may use to identify and authorize the onsite agent system 210 to communicate with the cloud hosting system 220. In some embodiments, as part of the registration process, the cloud hosting system 220 may provide the onsite agent system 210 with authorization and/or authentication information (e.g., credentials, keys, etc.) to allow the onsite agent system 210 and the cloud hosting system 220 to communicate. In some embodiments, the registration process may involve the use of a registry REST endpoint, and may assign the onsite agent system 210 with a unique ID and give rights of communication to the cloud hosting system 220 and topics/commands, used by the onsite agent system 210 for data ingestion, to fetch configuration information notifications, and/or other messages from the cloud hosting system 220.

The process 500 also may include receiving configuration set defining data formatting and transmission parameters (block 520). For example, the onsite agent system 210 may receive the configuration set from the cloud hosting system 220. As described herein, the configuration set may be customizable (e.g., by a group, an organization, production engineers, etc.). In some embodiments, the cloud hosting system 220 may store a group of different configuration sets in which each configuration set is associated with a particular organization or group, type of data, type of data source, SLA, or the like. The cloud hosting system 220 may identify which configuration set should be sent to the onsite agent system 210 based on the registration information (e.g., received at block 510 as part of the registration process). As an example, the cloud hosting system 220 may identify the configuration set associated with a particular group's or organization's SLA or other information that balances data richness with data transmission and storage resource consumption efficiency. Additionally, or alternatively, the configuration set may factor in to account the network and/or storage capabilities and/or constraints of the cloud hosting system 220. As described herein, the configuration set may be customizable and define how data records (e.g., generated and provided by the data source systems 205) are formatted, the units to which to convert data within the data records, and transmission parameters/procedures for providing data records for storage on the cloud hosting system 220. Example transmission parameters may include batching instructions/procedures, file size limits, network paths, security protocols, QoS parameters, bandwidth limits, transmission times (e.g., off-peak transmission times to reduce costs), transmission time intervals, or the like.

In general, the configuration set identifies a contract or established parameters for how data records are to be converted and formatted, and the manner in which data records are to be transmitted to the cloud hosting system 220 for storage. As previously discussed, the configuration set may be based on an SLA or other information such that configuration set balances the data richness needs of a user group, workflow, etc., with the transmission and storage resource consumption efficiency and tolerance. In some embodiments, the onsite agent system 210 may receive the configuration set in conjunction with the registration with the cloud hosting system 220, or may receive the configuration set upon startup. Additionally, or alternatively, the onsite agent system 210 may receive the configuration set when a change to the configuration has been made, or may periodically request the configuration set from the cloud hosting system 220 (e.g., to verify that the latest configuration set is being implemented).

The process 500 further may include receiving data records from a data source system (block 530). For example, the onsite agent system 210 may receive data from a data source system 205. In some embodiments, the onsite agent system 210 may receive data records on either a push or pull basis, and may implement a scheduler to pull the data records at scheduled time periods. As described herein, the data records received from the data source system 205 may be any type of data, such as time series data from a historian, sensor data, structured data, etc. As one illustrative example, the data records may include oilfield data, such as sensor data of downhole equipment (e.g., the downhole equipment 154), data relating to resource recovery, equipment health, equipment operations, etc.

The process 500 also may include converting to units defined in the configuration set (block 540). For example, the onsite agent system 210 may convert units of the data record (received at block 530) to a standardized unit (e.g., SI units or other type of unit) as defined in the configuration set. The units may be converted such that all data records include standardized and/or consistent units to aid in data processing, interpretation, and/or analysis. In some embodiments, the unit conversion may also involve converting timestamps associated with the data into a standardized unit or time zone (e.g., UTC).

The process 500 further may include formatting the data records based on the configuration set (block 550). For example, the onsite agent system 210 may format the data in accordance with the configuration set defining formatting parameters of how the data is to be formatted. In some embodiments, the formatting may involve pruning, discarding, compressing, expanding, rearranging, and/or other types of modifications to the data. As described herein, the formatting may define the richness level of the data to balance data richness with transmission and storage efficiency. For example, one formatting configuration may include relatively richer data than a different formatting configuration.

The process 500 also may include batching the data records for transmission to the cloud hosting system (block 560). For example, the onsite agent system 210 may form batches of the formatted data records in accordance with the configuration set. In some embodiments, batching the formatted data records may reduce transmission costs by reducing the number of transmission sessions with the cloud hosting system 220.

The process 500 further may include providing the data records to the cloud hosting system (block 570). For example, the onsite agent system 210 may provide the data records (e.g., after batching at block 560) to the cloud hosting system 220. In some embodiments, the onsite agent system 210 may identify a time as to when to provide the data records to the cloud hosting system 220 based on a marker identifying a time when data records were previously streamed or provided to the cloud hosting system 220, and the configuration defining the time intervals for providing the data records to the cloud hosting system 220.

The process 500 may further include storing markers identifying the time of transmission (block 580). For example, the onsite agent system 210 may store markers or information identifying when data records were transmitted to the cloud hosting system 220. As described herein, the markers may be used to trigger a subsequent data transmission session after a certain period of time has elapsed.

As shown in FIG. 5, the process 500 may return to step 530 to convert, format, batch, and send additional data records as they are received from the data source system 205. As described herein with respect to the process 500, the onsite agent system 210 may provide the data records after converting, formatting, and batching (e.g., at blocks 540, 550, and 560) in accordance with the configuration set. In this way, data records are standardized in a consistent manner to facilitate improved data analysis, workflow execution, etc. Further, data records are transmitted for storage to the cloud hosting system 220 and formatted in a manner that balances data richness with transmission and storage resource consumption efficiency.

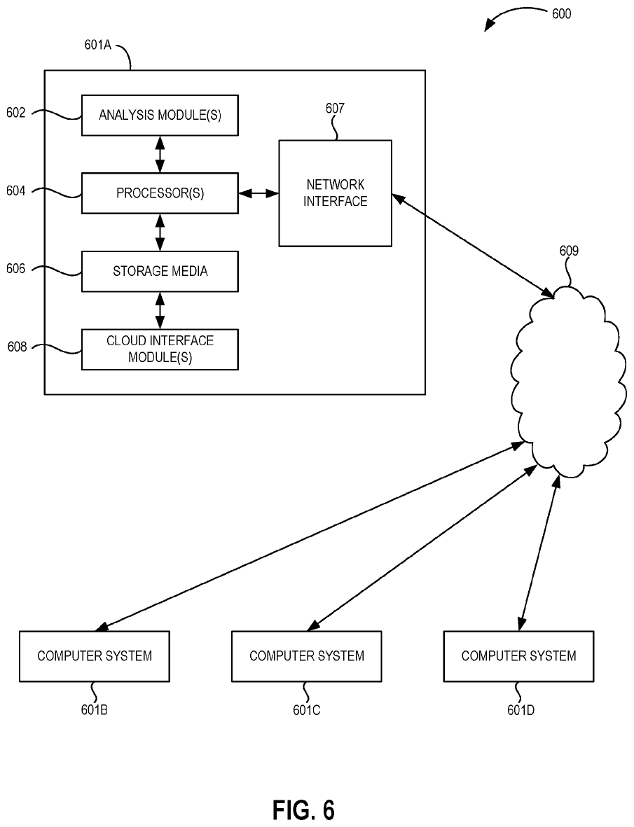

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more cloud interface module(s) 608. In the example of computing system 600, computer system 601A includes the cloud interface module 608. In some embodiments, a single cloud interface module may be used to perform some aspects of one or more embodiments of the methods disclosed herein. In other embodiments, a plurality of cloud interface modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for customized canonical data standardization, ingestion, and storage comprising:
receiving a configuration set defining a formatting parameter, a unit conversion parameter, and a transmission parameter;
receiving a data record from a data source, wherein the data record includes oilfield-related data;
converting units within the data record to a standardized unit defined based at least partially on the unit conversion parameter;
formatting the data record based at least partially on the formatting parameter, wherein the formatting parameter defines one or more modifications to make to the data record; and
providing the data record to a cloud hosting system for storage after converting the units and the formatting the data record, wherein the providing the data record comprises transmitting the data record in a manner defined by the configuration set.

2. The method of claim 1, further comprising:
receiving a plurality of data records from the data source;
converting units within each of the plurality of data records to the standardized unit;
formatting each of the plurality of data records based at least partially on the formatting parameters;
batching the plurality of data records after converting the units within each of the plurality of data records and formatting each of the plurality of data records to form data record batches, wherein the batching is based on batching procedures defined by the configurations set; and
providing the plurality of data records in the batches.

3. The method of claim 1, wherein the data record includes at least one type of data selected from the group consisting of:
historian data;
incremental data;
structured data;
non-structured data; and
sensor data.

4. The method of claim 1, wherein the configuration set defines richness level of data record.

5. The method of claim 1, further comprising registering the agent system with the cloud hosting system, wherein the cloud system authorizes the agent system to communicate with the cloud hosting system based on the registering.

6. The method of claim 1, further comprising:
determining that the configuration set defines parameters outside of a tolerance threshold; and
discarding the configuration set based on the determining.

7. The method of claim 1, wherein the cloud hosting system verifies that the data record matches the formatting parameters prior to storage of the data record.

8. The method of claim 1, wherein the agent system provides health metrics to the cloud hosting system.

9. The method of claim 1, wherein the configuration set is a particular configuration set of a plurality of configuration sets, wherein the cloud hosting system selects the particular configuration set based on registration information of an agent system, and wherein the agent system performs the converting the units, the formatting the data record, and the providing the data record based at least partially on the particular configuration set.

10. The method of claim 1, further comprising generating a marker identifying a time in which the data record is provided to the cloud hosting system, wherein the marker is configured to identify a subsequent time to provide a subsequent data record to the cloud hosting system.

11. A computing system, comprising:
one or more processors; and
a memory system comprising one or more non-transitory computer-readable media storing instructions that, when executed by at least one of the one or more processors, cause the computing system to perform operations, the operations comprising:
receiving a configuration set defining a formatting parameter, a unit conversion parameter, and a transmission parameter;
receiving a data record from a data source, wherein the data record includes oilfield-related data;
converting units within the data record to a standardized unit defined based at least partially on the unit conversion parameter;
formatting the data record based at least partially on the formatting parameter, wherein the formatting parameter defines one or more modifications to make to the data record; and
providing the data record to a cloud hosting system for storage after converting the units and the formatting the data record, wherein the providing the data record comprises transmitting the data record in a manner defined by the configuration set.

12. The computing system of claim 11, wherein the operations further comprise:
receiving a plurality of data records from the data source;
converting units within each of the plurality of data records to the standardized unit;
formatting each of the plurality of data records based at least partially on the formatting parameters;
batching the plurality of data records after converting the units within each of the plurality of data records and formatting each of the plurality of data records to form data record batches, wherein the batching is based on batching procedures defined by the configurations set; and
providing the plurality of data records in the batches.

13. The computing system of claim 11, wherein the data record includes at least one type of data selected from the group consisting of:
historian data;
incremental data;
structured data;
non-structured data; and
sensor data.

14. The computing system of claim 11, wherein the configuration set defines richness level of data record.

15. The computing system of claim 11, wherein the operations further comprise:
registering the agent system with the cloud hosting system, wherein the cloud system authorizes the agent system to communicate with the cloud hosting system based on the registering.

16. The computing system of claim 11, wherein the operations further comprise:
determining that the configuration set defines parameters outside of a tolerance threshold; and
discarding the configuration set based on the determining.

17. The computing system of claim 11, wherein the cloud hosting system verifies that the data record matches the formatting parameters prior to storage of the data record.

18. A non-transitory computer-readable medium storing instructions that, when executed by one or more processors of a computing system, cause the computing system to perform operations, the operations comprising:
receiving a configuration set defining a formatting parameter, a unit conversion parameter, and a transmission parameter;
receiving a data record from a data source, wherein the data record includes oilfield-related data;
converting units within the data record to a standardized unit defined based at least partially on the unit conversion parameter;
formatting the data record based at least partially on the formatting parameter, wherein the formatting parameter defines one or more modifications to make to the data record; and
providing the data record to a cloud hosting system for storage after converting the units and the formatting the data record, wherein the providing the data record comprises transmitting the data record in a manner defined by the configuration set.

19. The non-transitory computer-readable medium of claim 18, wherein the operations further comprise:
receiving a plurality of data records from the data source;
converting units within each of the plurality of data records to the standardized unit;
formatting each of the plurality of data records based at least partially on the formatting parameters;
batching the plurality of data records after converting the units within each of the plurality of data records and formatting each of the plurality of data records to form data record batches, wherein the batching is based on batching procedures defined by the configurations set; and
providing the plurality of data records in the batches.

20. The non-transitory computer-readable medium of claim 18, wherein the cloud hosting system verifies that the data record matches the formatting parameters prior to storage of the data record.
